(19) United States
(12) Patent Application Publication
(10) Pub. No.: US 2026/0246729 A1
(43) Pub. Date: Aug. 20, 2026

(54) GENERIC INTEROPERABILITY AMONG MULTICAST PROTOCOLS

(71) Applicant: Hewlett Packard Enterprise Development LP, Spring, TX (US)

(72) Inventors: Anil Raj, Bangalore (IN); Tathagata Nandy, Bangalore (IN)

(21) Appl. No.: 19/187,387

(22) Filed: Apr. 23, 2025

(30) Foreign Application Priority Data
Jan. 29, 2025 (IN) 20254-1007377

(51) Int. Cl. H04L 45/16; H04L 12/18; H04L 45/64

(52) U.S. Cl. CPC H04L 45/16; H04L 12/185; H04L 45/64

(57) ABSTRACT

A first network device in a first segment of a network can operate as an RP of a first multicast protocol. A respective multicast route in the first segment is established based on the first multicast protocol. Operating as an RP, the first network device can receive a first join request of the first multicast protocol for a multicast group. The first network device can then generate a second join request for the multicast group based on a second multicast protocol and send the second join request to a second network device in an overlay network coupled to a plurality of segments of the network. Subsequently, the first network device can receive multicast traffic of the multicast group from a second segment of the network via the second network device.

### BACKGROUND

A network device, such as a switch, may be deployed in different network topologies. For example, the network device can be deployed in a network with multiple segments (e.g., different sites of an enterprise network). As a result, the network device may send and receive packets to and from these segments. These segments may run different multicast protocol variants, such as Protocol Independent Multicast (PIM) sparse-mode (PIM-SM) and Multicast Border Gateway Protocol (MBGP).

### BRIEF DESCRIPTION OF THE FIGURES

FIG. 1 illustrates an example of a network forwarding multicast traffic between segments running different multicast protocol variants, in accordance with an aspect of the present application.

FIG. 2 illustrates a network device swapping join requests for facilitating multicast traffic forwarding between segments in a network running different multicast protocol variants, in accordance with an aspect of the present application.

FIG. 3 presents a flowchart illustrating an example of a process of a network device facilitating multicast traffic forwarding between segments in a network running different multicast protocol variants, in accordance with an aspect of the present application.

FIG. 4A presents a flowchart illustrating an example of a process of a network device programming forwarding hardware based on swapping join requests for forwarding multicast traffic received from a segment running a different multicast protocol variant, in accordance with an aspect of the present application.

FIG. 4B presents a flowchart illustrating an example of a process of a network device receiving multicast traffic from a segment running a different multicast protocol variant, in accordance with an aspect of the present application.

FIG. 5A presents a flowchart illustrating an example of a process of a network device in an overlay network facilitating multicast traffic forwarding between segments in an external network running different multicast protocol variants, in accordance with an aspect of the present application.

FIG. 5B presents a flowchart illustrating an example of a process of a network device in an overlay network programming forwarding hardware for forwarding multicast traffic received from a segment in an external network, in accordance with an aspect of the present application.

FIG. 6 illustrates an example of a computing system facilitating multicast traffic forwarding between segments of an external network running different multicast protocol variants, in accordance with an aspect of the present application.

FIG. 7 illustrates an example of a computer-readable medium (CRM) facilitating multicast traffic forwarding between segments of a network running different multicast protocol variants, in accordance with an aspect of the present application.

In the figures, like reference numerals refer to the same figure elements.

### DETAILED DESCRIPTION

Multicast technology plays a crucial role in various Internet applications, allowing efficient content distribution from a single source to multiple hosts through network devices such as switches and routers. This method of data transmission significantly enhances network performance by optimizing bandwidth usage and reducing redundant traffic. To facilitate the distribution of multicast content across a network, network-layer multicast protocols are employed. One commonly used protocol is Protocol-Independent Multicast (PIM), which constructs and maintains multicast distribution trees to ensure efficient delivery of content to all intended recipients. Hosts wishing to receive traffic from a specific multicast group can initiate the process by sending a client join request to an upstream network device. This join request can take the form of an Internet Group Management Protocol (IGMP) request in Internet Protocol (IP) version 4 (IPv4) networks or a Multicast Listener Discovery (MLD) request in IP version 6 (IPv6) networks. The network device that receives this join request is referred to as the requesting network device.

In a multicast distribution process, the requesting network device can send a network join request (e.g., a PIM join request) to a source network device coupled to the source of the multicast group. Upon receiving this request, the source network device begins forwarding multicast traffic to the requesting network device, establishing a path for content distribution. In more advanced network configurations, some network devices may operate in an overlay network. This overlay network is typically formed using overlay routing techniques for a Virtual Private Network (VPN) across a set of tunnels. One example of an overlay network is the deployment of an Ethernet VPN (EVPN) as an overlay on top of a set of Virtual Extensible Local Area Networks (VXLANs). An overlay network with a VPN can also be referred to as a distributed tunnel fabric. Within this overlay fabric architecture, communication between a pair of network devices within a fabric occurs through a dedicated tunnel between the two. Consequently, each network device within the overlay network functions as a tunnel endpoint. This tunneling mechanism provides a secure and efficient means of transmitting data across the network.

A network may include multiple network segments, each segment can be deployed in a site of the network (e.g., different sites of an enterprise network). Different segments of the network may be coupled to each other through corresponding border network devices (or border devices) via an overlay network. Typically, a border device of a segment can be responsible for forwarding traffic to and from the segment. If the network includes multiple segments, a source and a host of a multicast group can be in different segments of the network and, hence, separated by the overlay network. As a result, the traffic from the source to the host can be forwarded from one segment to another via the overlay network. These segments may run different multicast protocol variants, such as PIM-SM and bidirectional PIM (PIM-BIDIR). However, PIM-SM and PIM-BIDIR may not be fully interoperable with each other. Therefore, the host may not receive multicast traffic from the source.

The aspects described herein address the problem of loss of multicast traffic forwarded between segments of a network by (i) upon receiving a network join request for a multicast group, generating a corresponding client join request at a border device of a segment, and sending it to the overlay network; and (ii) in response to receiving multicast traffic from the overlay network based on the client join request, forwarding the multicast traffic in the segment based on the network join request. When a network device in the overlay network receives the client join request, the network device can send a notification message comprising multicast information, such as the multicast group address, to a respective other network device. Based on the notification message, the network device can receive the multicast traffic of the multicast group via the overlay network. In accordance with the client join request, the network device can forward the multicast traffic to the border device, which can then forward the multicast traffic in the segment.

Currently, a network may include a plurality of segments (e.g., different sites of an enterprise network). These segments can be coupled to each other via an overlay network (e.g., a tunnel fabric). Typically, a border device, such as a customer edge (CE) device (e.g., a CE switch), can couple a segment to the overlay network. Correspondingly, traffic to and from the segment is forwarded by the border device. Since these segments may have different multicast requirements, different segments may deploy different multicast protocol variants, such as PIM-SM, PIM-BIDIR, MBGP, Distance Vector Multicast Routing Protocol (DVMRP), Core Based Trees (CBT), and Source-Specific Multicast (SSM).

During operation, a network device coupling a source of a multicast group can receive multicast traffic of the multicast group. Such a network device can be referred to as a source network device. The source network device can operate as the source-connected designated router (DR) or source DR, which is responsible for forwarding multicast traffic to a requesting network device. The requesting network device can operate as the client-connected DR or client DR, which is responsible for requesting multicast traffic for a multicast group. For a multicast protocol, such as the PIM-SM, the source of a multicast group can register with the RP. A requesting network device can send a network join request to the RP, which can then forward it to the source network device. Subsequently, the source network device can determine, based on the network join request, which network device has requested data from the multicast group. The source network device can then forward the multicast traffic to the requesting network devices.

If the source and one or more hosts are in different network segments, the overlay network coupled to these segments can forward the multicast traffic. In the overlay network, multicast traffic for the multicast group can be forwarded via an established tunnel between the requesting network device and the source network device. This approach ensures that multicast traffic is efficiently distributed across the overlay network while maintaining the benefits of the underlying VPN infrastructure. To efficiently forward multicast traffic in an overlay network, upon receiving a client join request (e.g., an IGMP join request) for a multicast group, a requesting network device can send a notification message to a source network device via a corresponding tunnel. The notification message can indicate that the requesting network device has received a request to receive multicast traffic of the multicast group. In other words, a device reachable via the requesting network device has requested multicast traffic of the multicast group. Accordingly, the source network device can send the multicast traffic to the requesting network device instead of forwarding it to all other network devices in the overlay network.

When the source and at least one host are in different segments, these segments can deploy different multicast protocols, which may not be fully interoperable with each other. For example, a source can be coupled to a segment running PIM-SM, and a host can be coupled to another segment running PIM-BIDIR. Here, PIM-SM and PIM-BIDIR may not be fully interoperable with each other. Therefore, when the requesting network device sends a network join request toward the source, the border device of the segment can receive the network join request and forward it via the overlay network. However, since the border device of the source segment runs a different multicast protocol, the border device may not recognize the network join request and discard it. As a result, the host may not receive multicast traffic from the source.

To address this issue, the border devices can operate as rendezvous points (RPs) of corresponding multicast protocols and send, upon receiving a network join request for a multicast group, a corresponding client join request. Because the border device of a segment can operate as the RP, the network join requests generated in that segment can be forwarded to the border device operating as the RP. Usually, network devices support a typical client multicast protocol, such as IGMP, using which a host requests to join a multicast group. As a result, even if different segments of the network run different multicast protocol variants, a respective network device of a respective segment may run the same client multicast protocol. It should be noted that a client multicast protocol is distinct from a network multicast protocol, such as PIM-SM or PIM-BIDIR, using which multicast routes are established in a network. Usually, network devices use a network multicast protocol to establish the multicast routes.

Accordingly, when the border device receives a network join request (e.g., a PIM join) from another network device in the segment, the border device can generate a corresponding client join request (e.g., an IGMP join) based on the information indicated in the network join request. For example, if the network join request specifies a source and a multicast group, the client join request can be for the same source and multicast group combination. Here, the border device and the segment can be referred to as the requesting border device and the requesting segment, respectively. The requesting border device can store the information indicated in the network join request in an entry in a data structure. For example, the entry can include the multicast address of the multicast group.

Since the requesting border device is coupled to the overlay network, the requesting border device can send the client join request to the overlay network. A network device of the overlay network can receive the client join request from the border device and send a notification message to all other network devices of the overlay network via corresponding tunnels. The network device can be referred to as a requesting network device since the requesting border device is coupled to this network device. The notification message can indicate that a device reachable via the network device has requested multicast traffic of a multicast group (e.g., seeks to join the multicast group). The notification message can specify the multicast address, such as a multicast IP address, of the multicast group. In some examples, the notification message can be an EVPN type-6 message, which is used to share multicast-related information in the overlay network.

When another network device of the overlay receives the notification message, the receiving network device can generate the corresponding client join request for the multicast group based on the information in the notification message. The receiving network device can then send the client join request to the border device of the segment coupled to the receiving network device. If the source of the multicast group is in the segment, the border device and the segment can be referred to as the source border device and the source segment, respectively. When the source starts transmitting the multicast traffic of the multicast group, the source border device can receive the multicast traffic since it is configured as the RP of the multicast protocol running in the source segment. The multicast traffic can include a set of multicast packets of the multicast group. The set of multicast packets can be destined to a multicast group address representing the multicast group.

Based on the client join request received from the overlay network, the source border device can start sending the multicast traffic to the network device of the overlay network coupled to the source border device. This network device can be referred to as the source network device since the source border device is coupled to this network device. In accordance with the information in the notification message from the requesting network device, the source network device can determine where to send the multicast traffic. To do so, the source network device can encapsulate the multicast traffic with an encapsulation header with the requesting network device's IP address as the destination address to generate the encapsulated multicast traffic. Subsequently, the source network device can forward the encapsulated multicast traffic to the requesting network device over the corresponding tunnel.

When the requesting network device receives the encapsulated multicast traffic, the requesting network device can decapsulate the encapsulation header and obtain the multicast traffic. Based on the client join request received from the requesting border device, the requesting network device of the overlay network can forward the multicast traffic to the requesting border device. The requesting border device can then generate a corresponding multicast route (mroute) entry in the forwarding hardware of the requesting border device based on the network join request, which has been stored in the data structure. The mroute can include the multicast address of the multicast group, the port that has received the multicast traffic as the ingress port, and the port that has received the network join request as the egress port. Since the mroute is not dependent on the multicast protocol running in this segment or the source segment, the requesting border device can start forwarding traffic to the host in the requesting segment using the mroute. In this way, multicast traffic can be forwarded between segments of the network even when these segments run different multicast protocol variants.

In this disclosure, the term “switch” is used in a generic sense, and it can refer to any standalone network device or fabric switch operating in any network layer. “Switch” should not be interpreted as limiting examples of the present invention to layer-2 networks. Any device that can forward traffic to an external device or another switch can be referred to as a “switch.” Furthermore, if the switch facilitates communication between networks, the switch can be referred to as a gateway switch. Any physical or virtual device (e.g., a virtual machine or switch operating on a computing device) that can operate as a network device and forward traffic to an end device can be referred to as a “switch.” If the switch is a virtual device, the switch can be referred to as a virtual switch. Examples of a “switch” include, but are not limited to, a layer-2 switch, a layer-3 router, a routing switch, a component of a Gen-Z network, or a fabric switch comprising a plurality of similar or heterogeneous smaller physical and/or virtual switches.

The term “packet” refers to a group of bits that can be transported together across a network. “Packet” should not be interpreted as limiting examples of the present invention to a particular layer of a network protocol stack. “Packet” can be replaced by other terminologies referring to a group of bits, such as “message,” “frame,” “cell,” “datagram,” or “transaction.” Furthermore, the term “port” can refer to an endpoint of a link that can receive or transmit data. “Port” can also refer to the hardware, software, and/or firmware logic that can facilitate the operations of that port.

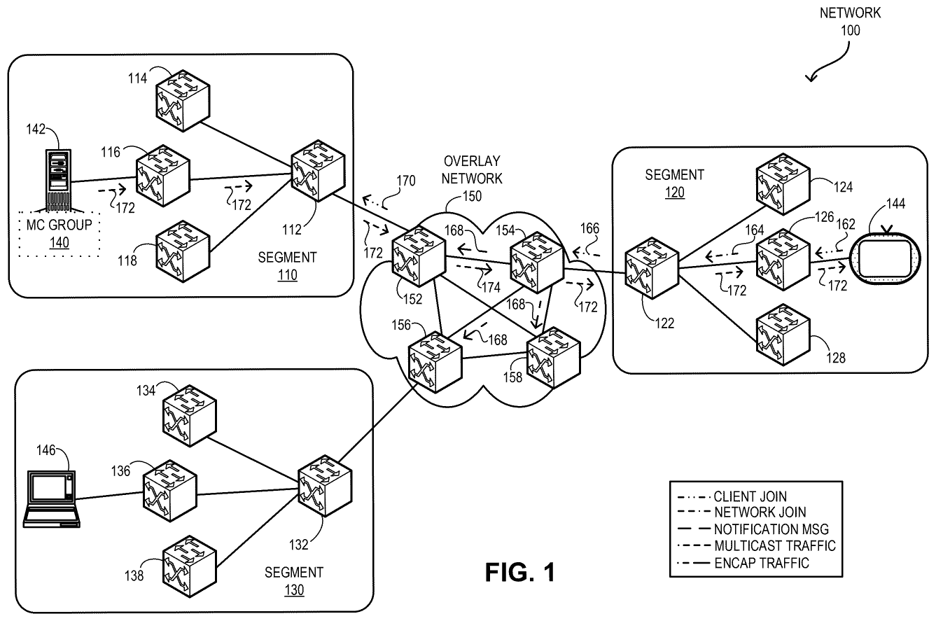

FIG. 1 illustrates an example of a network forwarding multicast traffic between segments running different multicast protocol variants, in accordance with an aspect of the present application. A network 100 can include a number of network devices (e.g., switches), and may include network components, such as layer-2 and layer-3 hops, and tunnels. In some examples, network 100 can be an Ethernet network, InfiniBand network, or other network, and may use a corresponding communication protocol, such as IP, FibreChannel over Ethernet (FCoE), or other protocols. Network 100 can include segments 110, 120, and 130 coupled to each other via network 150. For example, if network 100 is an enterprise network, segments 110, 120, and 130 can correspond to respective sites or departments of the enterprise. In this example, segment 110 can include network devices 112, 114, 116, and 118; segment 120 can include network devices 122, 124, 126, and 128; and segment 130 can include network devices 132, 134, 136, and 138.

A respective network device in network 100 can be associated with a MAC address and an IP address and can include at least one processing resource. Examples of a processing resource can include, but are not limited to, a processor core, a graphics processing unit (GPU), and a tensor processing unit (TPU). Network devices 112, 122, and 132 can couple segments 110, 120, and 130, respectively, to network 150, thereby operating as respective border devices. Currently, segments 110, 120, and 130 may have different multicast requirements. As a result, different segments may deploy different multicast protocol variants. In network 100, segments 110, 120, and 130 can distribute multicast traffic using different protocols. Here, when a multicast protocol runs on a segment, a corresponding multicast protocol instance can be deployed on a respective network device of that segment. For example, if segment 120 runs PIM-BIDIR, a PIM-BIDIR instance can be deployed on a respective network device of segment 120.

In some examples, network 150 can be an overlay network, which can be a distributed tunnel fabric, where the network devices can be coupled to each other via tunnels. Network 150 can include network devices 152, 154, and 156. In overlay network 150, tunnel encapsulation is initiated and terminated within overlay network 150. Network devices in overlay network 150 may form a mesh of tunnels. Examples of a tunnel can include, but are not limited to, VXLAN, Generic Routing Encapsulation (GRE), Network Virtualization using GRE (NVGRE), Generic Networking Virtualization Encapsulation (Geneve), Internet Protocol Security (IPsec), and Multiprotocol Label Switching (MPLS). A VPN, such as an EVPN, can be deployed over overlay network 150. The tunnels in overlay network 150 can be formed over an underlay network. The underlay network can be a physical network, and a respective link of the underlay network can be a physical link.

A respective network device in overlay network 150 can also be in the underlay network. Therefore, a network device operating as a tunnel endpoint can also be in the underlay network. A respective pair of network devices in the underlay network can be a BGP peer. Therefore, in the underlay network, a respective network device can use BGP to establish routes via which packets are forwarded. Accordingly, the encapsulated packets of overlay network 150 can be forwarded via these routes in the underlay network. Network devices 152, 154, and 156 can be coupled to segments 110, 120, and 130, respectively. In this example, network devices 112, 122, and 132 are the border devices of segments 110, 120, and 130, respectively. Hence, network devices 152, 154, and 156 can be coupled to network devices 112, 122, and 132, respectively. The encapsulation of packets is initiated and terminated within overlay network 150. As a result, from the perspective of overlay network 150, segments 110, 120, and 130 can be in an external network since the tunnels of overlay network 150 are not extended to segments 110, 120, and 130, which are outside of and are coupled to overlay network 150.

End devices 142, 144, and 146 can be coupled to network devices 116, 126, and 136, respectively. End device 142 can be the source for multicast group 140 and, hence, can be referred to as source 142. Therefore, multicast traffic 172 (e.g., a stream of multicast packets) of multicast group 140 can be sent from source 142. Network device 116, which can be the source DR, can receive multicast traffic 172 from source 142. If end device 144 requests traffic for multicast group 140, end device 144 can send a client join request 162 (e.g., an IGMP or MLD join) to network device 126, which can be the client DR. Therefore, end device 144 can also be referred to as a requesting host 144 (or host 144). Network device 126 can then send a network join request 164 (e.g., PIM join) in segment 120. Join request 164 can be supported by the multicast protocol running on segment 120.

In network 100, source 142 and host 144 are in different segments 110 and 120, respectively. Suppose that segments 110 and 120 deploy PIM-SM and PIM-BIDIR, respectively. A respective multicast route in segment 110 can be established based on PIM-SM, and a respective multicast route in segment 120 can be established based on PIM-BIDIR. In this example, source 142 can be coupled to segment 110 running PIM-SM, and host 144 can be coupled to segment 120 running PIM-BIDIR. Here, PIM-SM and PIM-BIDIR may not be fully interoperable with each other. When join request 164 is sent, border device 122 of segment 120 can receive join request 164 and send it to network device 154 for forwarding it via overlay network 150. Subsequently, border device 112 of segment 110 can receive join request 164 via overlay network 150. However, since segment 110 runs a different multicast protocol, border device 112 may not recognize join request 164 and discard it. As a result, host 144 may not receive multicast traffic 172.

To address this issue, border devices 112, 122, and 132 can operate as RPs of the multicast protocols running on segments 110, 120, and 130, respectively. Because border device 122 can operate as the RP in segment 120, join request 164 can be forwarded to border device 122. Upon receiving join request 164 from network device 126, border device 122 can generate a corresponding client join request 166 (e.g., an IGMP join) based on the information indicated in join request 164. For example, if join request 164 specifies the respective addresses of source 142 and multicast group 140, join request 166 can also be for the same combination of source 142 and multicast group 140. Furthermore, border device 122 can also store the information indicated in join request 164 in an entry in a data structure. For example, the entry can include the multicast address of multicast group 140.

Since border device 122 is the RP in segment 120, a source of multicast group 140 in segment 120, if any, can register with the RP (i.e., with border device 122). In this example, border device 122 can determine that no device in segment 120 has been registered as the source of multicast group 140. Hence, border device 122 can determine that the source of multicast group 140 is outside of segment 120. Since border device 122 is coupled to network device 154 of overlay network 150, network device 154 can be the upstream device of border device 122. Therefore, border device 122 can send join request 166 to overlay network 150 through network device 154. Network device 154 can receive join request 166 and send notification message 168 to network devices 152, 156, and 158 via corresponding tunnels of overlay network 150.

Notification message 168 can indicate that a device reachable via network device 154 (e.g., coupled to network device 154) has requested multicast traffic of multicast group 140 (e.g., seeks to join multicast group 140). Notification message 168 can specify the multicast address, such as a multicast IP address, of multicast group 140. In this example, the device can be border device 122, which has sent join request 166 to network device 154 and, hence, has requested to join multicast group 140. If overlay network 150 is an EVPN tunnel fabric, notification message 168 can be an EVPN type-6 message, which is typically used to share multicast-related information in overlay network 150.

When network device 152 in overlay network 150 receives notification message 168, network device 152 can generate client join request 170 for multicast group 140 based on the information in notification message 168. Since notification message 168 is generated based on join request 166, and join request 170 is generated based on notification message 168, join request 170 can correspond to join request 166. Network device 152 can then send join request 170 to border device 112 coupled to network device 152. When source 142 starts transmitting multicast traffic 172 of multicast group 140, border device 112 can receive multicast traffic 172 since border device 112 is configured as the RP in segment 110. Multicast traffic 172 can include a set of multicast packets of multicast group 140. The set of multicast packets can be destined to a multicast group address representing multicast group 140.

Since border device 112 has received client join request 170 from overlay network 150, border device 112 can send multicast traffic 172 to overlay network 150. In other words, based on join request 170, border device 112 can start sending multicast traffic 172 to network device 152 coupled to border device 112. In accordance with the information in notification message 168 from network device 154, network device 152 can determine where to send multicast traffic 174. To do so, network device 152 can encapsulate multicast traffic 172 with an encapsulation header with network device 154's IP address as the destination address to generate encapsulated multicast traffic 174. In encapsulated multicast traffic 174, a respective packet of the set of multicast packets can be encapsulated with such an encapsulation header. Network device 152 can then forward encapsulated multicast traffic 174 to network device 154 over a corresponding tunnel in overlay network 150.

When network device 154 receives encapsulated multicast traffic 174, network device 154 can decapsulate the encapsulation header and obtain multicast traffic 172. Based on join request 166 received from border device 122, network device 154 can forward multicast traffic 172 to border device 122. Border device 122 can then generate a corresponding mroute entry in the forwarding hardware of border device 122 based on the information obtained from join request 164, which has been stored in the data structure. The mroute can include the multicast address of multicast group 140, the port that has received multicast traffic 172 as the ingress port, and the port that has received join request 164 as the egress port. Since the mroute is not dependent on the multicast protocols running on segment 112 or 122, border device 122 can start forwarding multicast traffic 172 to network device 126. Upon receiving multicast traffic 172, network device 126 can forward multicast traffic 172 to host 144 based on join request 162. In this way, multicast traffic 172 can be forwarded between segments 110 and 120 even when these segments run different multicast protocol variants.

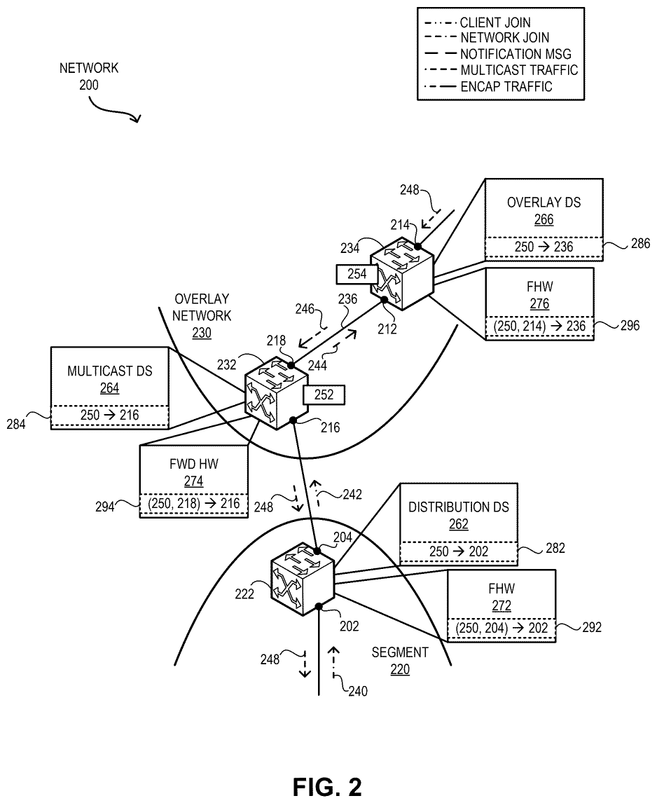

FIG. 2 illustrates a network device swapping join requests for facilitating multicast traffic forwarding between segments in a network running different multicast protocol variants, in accordance with an aspect of the present application. A network 200 can include a number of network devices (e.g., switches), and may include network components, such as layer-2 and layer-3 hops, and tunnels. In some examples, network 200 can be an Ethernet network, InfiniBand network, or other network, and may use a corresponding communication protocol, such as IP, FibreChannel over Ethernet (FCoE), or other protocols. Network 200 can include a number of segments, such as segment 220. For example, if network 200 is an enterprise network, segment 220 can correspond to a site department of the enterprise. In this example, segment 220 can include one or more network devices, such as network device 222.

A respective network device in network 200 can be associated with a MAC address and an IP address and can include at least one processing resource. Examples of a processing resource can include, but are not limited to, a processor core, a GPU, and a TPU. Network device 222 can couple segment 220 to network 230, thereby operating as a border device of segment 220. In network 200, segment 220 can distribute multicast traffic using a different multicast protocol than the multicast protocols of other segments. For example, segment 220 may run PIM-BIDIR, while other segments of network 220 can run PIM-SM.

In some examples, network 230 can be an overlay network, which can be a distributed tunnel fabric, where the network devices can be coupled to each other via tunnels. Network 230 can include a number of network devices, such as network devices 232 and 234. Network devices 232 and 234 can be associated with IP addresses 252 and 254, respectively. Network devices in overlay network 230 may form a mesh of tunnels. Examples of a tunnel can include, but are not limited to, VXLAN, GRE, NVGRE, Geneve, IPsec, and MPLS. A VPN, such as an EVPN, can be deployed over overlay network 230.

In network 200, a requesting host for a multicast group can be coupled to segment 220, and the source can be coupled to another segment reachable via network device 234 of overlay network 230. Therefore, the source and the host can be in segments running different multicast protocol variants that may not be fully interoperable with each other. To facilitate the forwarding of multicast traffic of the multicast group to the host, border device 222 can operate as RP in segment 220. Because border device 222 can operate as the RP, a network join request 240 can be forwarded to border device 222. During operation, border device 222 can receive join request 240 via port 202 of border device 222. Join request 240 can be sent by another network device in segment 220.

Border device 222 can then store the information indicated in join request 240 in an entry 282 in a distribution data structure 262. Distribution data structure 262 can be stored in the memory of border device 222. Suppose that join request 240 includes multicast address 250 (e.g., a multicast IP address) of the multicast group. Therefore, entry 282 can include multicast address 250. Since join request 240 has been received from port 202, entry 282 can also indicate that multicast traffic destined to multicast address 250 should be forwarded via port 202. In entry 282, port 202 can be represented by a port identifier of port 202.

Usually, network devices of network 200 support a typical client multicast protocol, such as IGMP, using which a host requests to join a multicast group. As a result, even if different segments of network 200 run different multicast protocol variants, a respective network device of a respective segment of network 200 may run the same client multicast protocol. Therefore, border device 222 can generate a client join request 242 (e.g., an IGMP join) based on the information indicated in join request 240. For example, if join request 240 includes multicast address 250, join request 242 can also include multicast address 250 and, hence, can be for the same multicast group. Border device 222 can determine that the source of the multicast group is outside of segment 220. Hence, border device 222 can send join request 242 to network device 232 via port 204 of border device 222.

Network device 232 can receive join request 242 via port 216 of network device 232. Network device 232 can then store the information in join request 242 in entry 284 of a multicast data structure 264, which can be stored in the memory of network device 232. Here, multicast data structure 264 can store information obtained from client join requests in accordance with a corresponding client multicast protocol, such as IGMP. Entry 284 can include multicast address 250. Since join request 242 has been received from port 216, entry 284 can also indicate that multicast traffic destined to multicast address 250 should be forwarded via port 216. In entry 284, port 216 can be represented by a port identifier of port 216.

Network device 232 can send a notification message 244 to other network devices of overlay network 230 via corresponding tunnels. For example, network device 232 can send notification message 244 to network device 234 via tunnel 236 between network devices 232 and 234. Notification message 244 can indicate that a device coupled to network device 232 has requested the multicast traffic destined to multicast address 250 (e.g., seeks to join the multicast group). Notification message 244 can specify multicast address 250 of the multicast group and IP address 252 of network device 232. In this example, the device requesting the multicast traffic can be border device 222, which has sent join request 242 to network device 232 and, hence, has requested to join the multicast group. If overlay network 230 is an EVPN tunnel fabric, notification message 244 can be an EVPN type-6 message, which is typically used to share multicast-related information in overlay network 230.

Network device 234 can receive notification message 244 from tunnel 236 via port 212 of network device 234. Here, the tunnel interfaces of tunnel 236 at network devices 232 and 234 can correspond to ports 218 and 212, respectively. Therefore, traffic exchanged over tunnel 236 is sent and received via ports 218 and 212. Therefore, network device 234 can receive notification message 244 forwarded over tunnel 236 from port 212. Network device 234 can then store the information in notification message 244 in an entry 286 of an overlay data structure 266, which can be stored in the memory of network device 234.

Here, overlay data structure 266 can store information obtained from other network devices of overlay network 230. Entry 286 can include multicast address 250, as indicated in notification message 244. Since notification message 244 has been received from tunnel 236, entry 286 can also indicate that multicast traffic destined to multicast address 250 should be forwarded via tunnel 236. In entry 286, tunnel 236 can be represented by a tunnel identifier of tunnel 236. In some examples, the tunnel identifier can include IP addresses 252 and 254.

Suppose that the source of the multicast group is reachable from port 214 of network device 234. Therefore, network device 234 can start receiving multicast traffic 248 of the multicast group via port 214. Multicast traffic 248 can include a set of multicast packets destined to multicast address 250. Hence, network device 234 can look up destination multicast address 250 of multicast traffic 248 in overlay data structure 266 and determine corresponding entry 286. Based on the information in entry 286, network device 234 can determine that multicast traffic destined to multicast address 250 should be forwarded to tunnel 236. Network device 234 can then generate a corresponding mroute 296 based on the information obtained from entry 286. Mroute 296 can include multicast address 250 of the multicast group, port 214 as the ingress port, and tunnel 236 as the egress interface.

Mroute 296 can indicate that packets that are received from port 214 and destined to multicast address 250 are to be forwarded over tunnel 236. Hence, network device 234 can encapsulate multicast traffic 248 with an encapsulation header to generate encapsulated multicast traffic 246. The encapsulation header can include IP addresses 254 and 252 as the source and destination addresses, respectively. Subsequently, network device can send encapsulated multicast traffic 246 via port 214 because the tunnel interface of tunnel 236 corresponds to port 214 of network device 234. Based on the encapsulation header, encapsulated multicast traffic 248 can be forwarded to network device 232 over tunnel 236.

When network device 232 receives encapsulated multicast traffic 246 via port 218 of network device 232, network device 232 can decapsulate the encapsulation header and obtain multicast traffic 248. Network device 232 can then look up destination multicast address 250 of multicast traffic 248 in multicast data structure 264 and determine corresponding entry 284. Based on the information in entry 284, network device 232 can determine that multicast traffic destined to multicast address 250 should be forwarded to port 216. Network device 232 can then generate a corresponding mroute 294 based on the information obtained from entry 284. Mroute 294 can include multicast address 250 of the multicast group, port 218 as the ingress port, and port 216 as the egress port.

Hence, mroute 294 can indicate that packets that are received from port 218 and destined to multicast address 250 are to be forwarded via port 216. In mroute 294, ports 216 and 218 can be represented by their respective port identifiers. Network device 232 can then program mroute 294 in forwarding hardware 274 of network device 232. Programming mroute 294 can include generating an entry in a ternary content-addressable memory (TCAM) in forwarding hardware 274. Based on mroute 294, network device 232 can forward multicast traffic 248 via port 216.

Since network device 232 is coupled to border device 222 through port 216, border device 222 can receive multicast traffic 248 from port 204. Border device 222 can then look up destination multicast address 250 of multicast traffic 248 in distribution data structure 262 and determine corresponding entry 282. Based on the information in entry 282, border device 222 can determine that multicast traffic destined to multicast address 250 should be forwarded to port 202. Border device 222 can then generate a corresponding mroute 292 based on the information obtained from entry 282. Mroute 292 can include multicast address 250 of the multicast group, port 204 as the ingress port, and port 202 as the egress port.

Hence, mroute 292 can indicate that packets that are received from port 204 and destined to multicast address 250 are to be forwarded via port 202. In mroute 292, ports 202 and 204 can be represented by their respective port identifiers. Border device 222 can then program mroute 292 in forwarding hardware 272 of border device 222. Programming mroute 292 can include generating an entry in a TCAM in forwarding hardware 272. Based on mroute 292, border device 222 can forward multicast traffic 248 via port 202 in segment 220. Since mroutes 292 and 294 are not dependent on the multicast protocols running on segment 220 or overlay network 230, border device 222 can start forwarding multicast traffic 248 in segment 220 even if the source segment of the multicast group runs another multicast protocol variant.

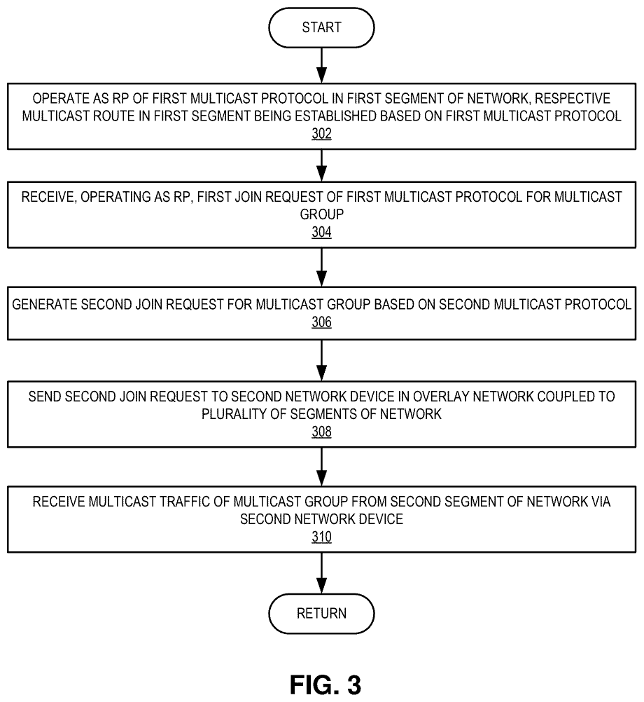

FIG. 3 presents a flowchart illustrating an example of a process of a network device facilitating multicast traffic forwarding between segments in a network running different multicast protocol variants, in accordance with an aspect of the present application. During operation, the network device can operate as an RP of a first multicast protocol in a first segment of a network (operation 302). Here, a respective multicast route in the first segment can be established based on the first multicast protocol. Since the network device operates as the RP, network join requests generated by other network devices of the segment can be forwarded to the network device. In the example in FIG. 1, border devices 112, 122, and 132 can operate as RPs of the multicast protocols running on segments 110, 120, and 130, respectively.

Accordingly, the network device, operating as the RP, can receive a first join request of the first multicast protocol for a multicast group (operation 304). The first join request can be a network join request, such as a PIM join. The first join request can be supported by the first network protocol. In the example in FIG. 1, because border device 122 can operate as the RP in segment 120, network join request 164 (e.g., PIM join) can be forwarded to border device 122. The network device can then generate a second join request for the multicast group based on the second multicast protocol (operation 306). Here, the second multicast protocol can be a client multicast protocol, such as IGMP, using which a host requests to join a multicast group. Typically, even if different segments of the network run different multicast protocol variants, a respective network device of a respective segment may run the same client multicast protocol. In the example in FIG. 1, upon receiving join request 164 from network device 126, border device 122 can generate a corresponding client join request 166 (e.g., an IGMP join) based on the information indicated in join request 164.

The network can include a plurality of segments (e.g., different sites of an enterprise network). These segments can be coupled to each other via the overlay network (e.g., a tunnel fabric). The network device can be a border device of the first segment and, hence, can be coupled to the overlay network. Accordingly, the network device can send the second join request to a second network device in an overlay network coupled to a plurality of segments of the network (operation 308). In the example in FIG. 1, since border device 122 is coupled to overlay network 150, border device 122 can send join request 166 to overlay network 150.

When the second network device receives multicast traffic of the multicast group from a second segment (e.g., the source segment) of the network, the second network device can send the multicast traffic to the network device based on the second join request. Therefore, the network device can receive the multicast traffic of the multicast group from the second segment via the second network device (operation 310). In the example in FIG. 1, when network device 154 receives encapsulated multicast traffic 174, network device 154 can decapsulate the encapsulation header and obtain multicast traffic 172. Based on join request 166 received from border device 122, network device 154 can forward multicast traffic 172 to border device 122.

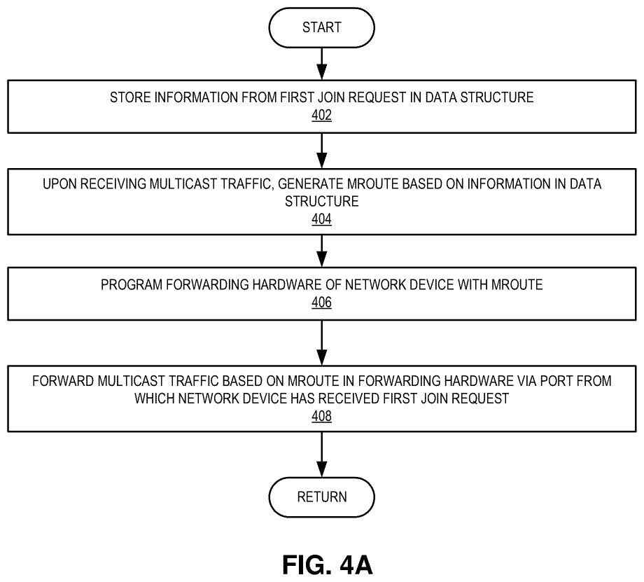

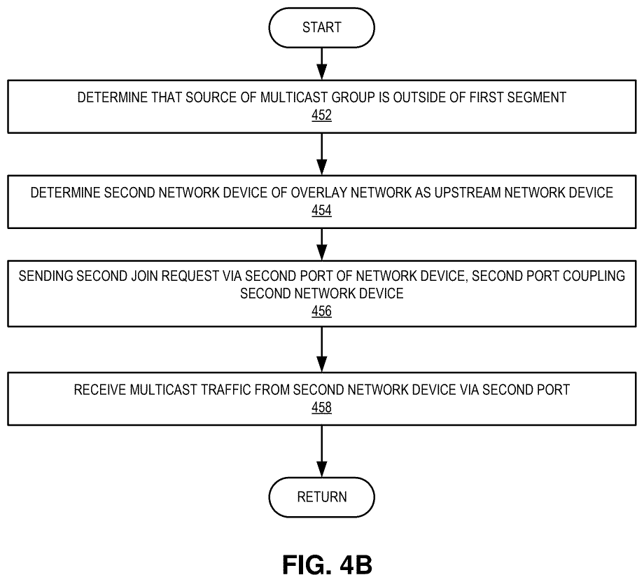

FIG. 4A presents a flowchart illustrating an example of a process of a network device programming forwarding hardware based on swapping join requests for forwarding multicast traffic received from a segment running a different multicast protocol variant, in accordance with an aspect of the present application. During operation, the network device can store the information from the first join request in a data structure (operation 402). Here, the network device and the first join request correspond to the network device and the first join request, respectively, of FIG. 3. The data structure can be stored in the memory of the network device. When the network device receives the first join request via a local port of the network device, the network device can generate an entry in the data structure and store information obtained from the first join request. The entry can include the multicast address of the multicast group. In the example in FIG. 2, border device 222 can store the information indicated in join request 240 in entry 282 in a distribution data structure 262. Entry 282 can include multicast address 250 and a port identifier of port 202.

Upon receiving the multicast traffic, the network device can generate an mroute (i.e., a multicast route) based on the information in the data structure (operation 404). The network device can look up the destination address of a packet in the multicast traffic in the data structure to determine the entry and obtain the information stored in the entry. The mroute can include the multicast address of the multicast group, the port that has received the multicast traffic as the ingress port, and the port that has received the first network join request as the egress port. In the example in FIG. 2, border device 222 can generate mroute 292 based on the information obtained from entry 282. Mroute 292 can include multicast address 250 of the multicast group, port 204 as the ingress port, and port 202 as the egress port.

The network device can then program the forwarding hardware of the network device with the mroute (operation 406). By programming the forwarding hardware with the mroute, the network device allows the forwarding hardware to forward the multicast traffic matching the mroute. Programming the mroute can include generating an entry in a TCAM in the forwarding hardware. In the example in FIG. 2, border device 222 can then program mroute 292 in forwarding hardware 272 of border device 222. The network device can then forward the multicast traffic based on the mroute in the forwarding hardware via the port from which the network device has received the first join request (operation 408). When the network device receives the first join request via the port, the network device can determine that the multicast traffic of the multicast group is to be forwarded via the port. Accordingly, the mroute can include the port as the egress port for the multicast traffic. In the example in FIG. 2, border device 222 can forward multicast traffic 248 via port 202, from which border device 222 received join request 240.

FIG. 4B presents a flowchart illustrating an example of a process of a network device receiving multicast traffic from a segment running a different multicast protocol variant, in accordance with an aspect of the present application. During operation, the network device can determine that the source of the multicast group is outside of the first segment (operation 452). Here, the network device, the multicast group, and the first segment correspond to the network device, the multicast group, and the first segment, respectively, of FIG. 3. The network device can determine that no device of the first segment has registered as the source of the multicast group. Hence, the network device can determine that the source of the multicast group is outside of the first segment. The network device can then determine the second network device of the overlay network as an upstream network device (operation 454). Since the network device can be coupled to the overlay network, the second network device can be the upstream switch. In the example in FIG. 2, when border device 222 determines that the source of the multicast group is outside of segment 220, border device 222 can determine network device 232 of overlay network 230 as the upstream device.

The network device can then send the second join request via the second port of the network device (operation 456). Here, the second port can couple the second network device. Since the source is outside of the first segment and the second network device is the upstream network device, the network device can send the second join request via the second port. In the example in FIG. 2, port 204 of border device 222 can be coupled to network device 232. Hence, border device 222 can send join request 242 via port 204. The network device can then receive multicast traffic from the second network device via the second port (operation 458). Based on the second join request, the second network device can send the multicast traffic of the multicast group to the network device. The network device can then receive the multicast traffic from the second port. In the example in FIG. 2, border device 222 can receive multicast traffic 248 from network device 232 via port 204.

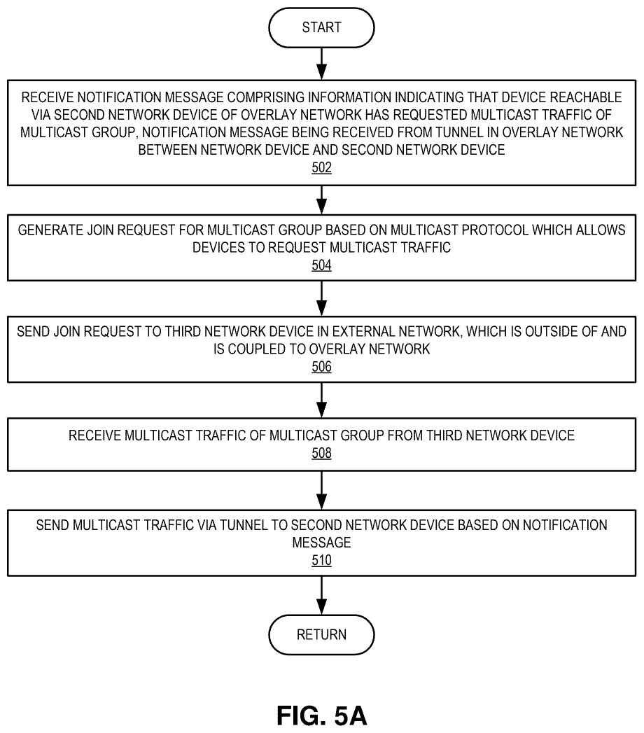

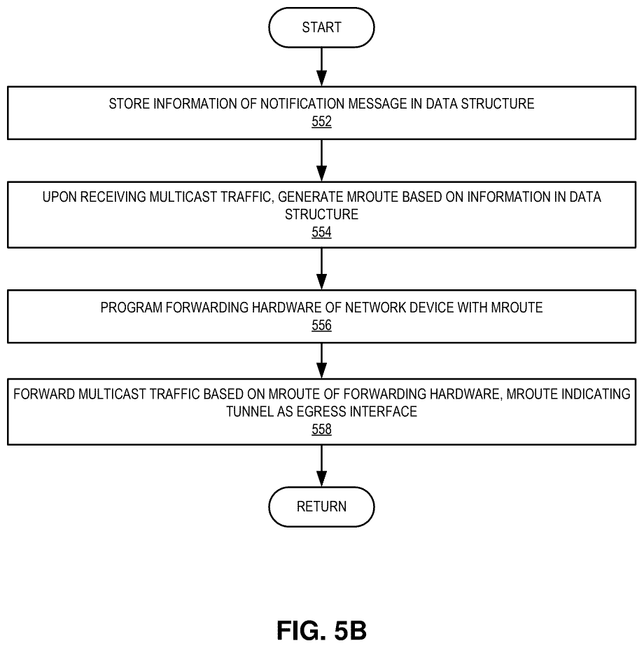

FIG. 5A presents a flowchart illustrating an example of a process of a network device in an overlay network facilitating multicast traffic forwarding between segments in an external network running different multicast protocol variants, in accordance with an aspect of the present application. During operation, the network device can receive a notification message indicating that a device reachable via a second network device of the overlay network has requested multicast traffic of a multicast group (operation 502). The notification message can be received by the network device from a tunnel in the overlay network between the network device and the second network device. If the overlay network is an EVPN network, the notification message can be an EVPN type-6 message. The notification message can include a multicast address of the multicast group. In the example in FIG. 1, network device 152 can receive a notification message 168 from network device 154 of overlay network 150 via a corresponding tunnel.

The network device can then generate a join request for the multicast group based on a multicast protocol, which allows devices to request multicast traffic (operation 504). This multicast protocol can be a client multicast protocol, such as IGMP or MLD, using which a device can request multicast traffic. A client multicast protocol is distinct from a network multicast protocol, such as PIM-SM or PIM-BIDIR, using which multicast routes are established in a network. In the example in FIG. 1, upon receiving notification message 168, network device 152 can generate a client join request 170. Subsequently, the network device can send the join request to a third network device in an external network, which is outside of and is coupled to the overlay network (operation 506). Here, the tunnels of the overlay network are not extended to the third network device and, hence, the third network device can be in a network external to the overlay network. In the example in FIG. 1, network device 152 can send join request 170 to border device 112 in segment 110.

The network device can receive multicast traffic of the multicast group from the third network device (operation 508). Based on the join request from the network device, the third network device can determine that the multicast traffic of the multicast group is to be forwarded to the network device. Accordingly, when the third network device receives the multicast traffic, the third network device can forward it to the network device. In the example in FIG. 1, network device 152 can receive multicast traffic 172 from border device 112. The network device can then send the multicast traffic via the tunnel to the second network device based on the notification message (operation 510). To do so, the network device can encapsulate the multicast traffic with an encapsulation header with the multicast address indicated in the notification message as the destination address. In the example in FIG. 1, network device 152 can encapsulate multicast traffic 172 with an encapsulation header and send encapsulated multicast traffic 174 to network device 154.

FIG. 5B presents a flowchart illustrating an example of a process of a network device in an overlay network programming forwarding hardware for forwarding multicast traffic received from a segment in an external network, in accordance with an aspect of the present application. During operation, the network device can store the information from the notification message in a data structure (operation 552). Here, the network device and the notification message correspond to the network device and the notification message, respectively, of FIG. 5A. The data structure can be stored in the memory of the network device. When the network device receives the notification message via a tunnel, the network device can generate an entry in the data structure and store information obtained from the notification message. The entry can include the multicast address of the multicast group and the tunnel from which the notification message is received. In the example in FIG. 2, network device 234 can store the information indicated in notification message 244 in entry 286 in data structure 266. Entry 286 can include multicast address 250 and an identifier of tunnel 236.

Upon receiving the multicast traffic, the network device can generate an mroute (i.e., a multicast route) based on the information in the data structure (operation 554). The network device can look up the destination address of a packet in the multicast traffic in the data structure to determine the entry and obtain the information stored in the entry. The mroute can include the multicast address of the multicast group, the port that has received the multicast traffic as the ingress port, and the tunnel as the egress interface. In the example in FIG. 2, network device 234 can generate mroute 296 based on the information obtained from entry 286. Mroute 296 can include multicast address 250 of the multicast group, port 218 as the ingress port, and tunnel 236 as the egress interface.

The network device can then program the forwarding hardware of the network device with the mroute (operation 556). By programming the forwarding hardware with the mroute, the network device allows the forwarding hardware to forward the multicast traffic matching the mroute. Programming the mroute can include generating an entry in a TCAM in the forwarding hardware. In the example in FIG. 2, network device 234 can then program mroute 296 in forwarding hardware 276 of network device 236. The network device can then forward the multicast traffic based on the mroute in the forwarding hardware (operation 558). Here, the mroute can indicate the tunnel as the egress interface. When the network device receives the notification message via the tunnel, the network device can determine that the multicast traffic of the multicast group is to be forwarded via the tunnel. Accordingly, the mroute can include the tunnel as the egress interface and, hence, can send the multicast traffic via the tunnel. In the example in FIG. 2, based on mroute 296, network device 234 can forward encapsulated multicast traffic 246 via tunnel 236 from which notification message 244 is received.

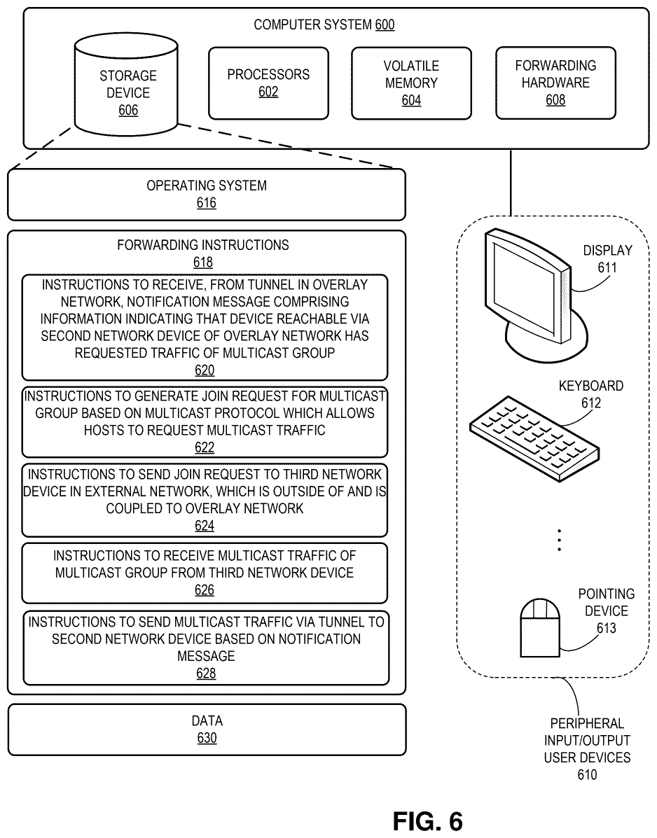

FIG. 6 illustrates an example of a computing system facilitating multicast traffic forwarding between segments of an external network running different multicast protocol variants, in accordance with an aspect of the present application. Computer system 600 includes one or more processors 602, a memory 604, a storage device 606, and forwarding hardware 608. Processors 602 can include one or more processing resources, such as processor cores, GPUs, and TPUs. Memory 604 can include a volatile memory (e.g., random access memory (RAM)) that serves as a managed memory and can be used to store one or more memory pools. Furthermore, computer system 600 can be coupled to peripheral I/O user devices 610 (e.g., a display device 611, a keyboard 612, and a pointing device 613). Forwarding hardware 608 can include a TCAM. Storage device 606 includes a non-transitory computer-readable storage medium and stores an operating system 616, forwarding instructions 618, and data 630. Computer system 600 may include fewer or more entities or instructions than those shown in FIG. 6.

Forwarding instructions 618 can include instructions, which when executed by computer system 600, can cause computer system 600 to perform methods and/or processes described in this disclosure. Forwarding instructions 618 can be executed on at least one of processors 602, forwarding hardware 608, or a combination thereof. Computer system 600 can be a network device in an overlay network, such as network device 152 in FIG. 1 and network device 232 in FIG. 2. Specifically, forwarding instructions 618 may include instructions 620 to receive a notification message comprising information indicating that a device reachable via a second network device of the overlay network has requested multicast traffic of a multicast group. The notification message can be received by computer system 600 from a tunnel in the overlay network between computer system 600 and the second network device.

Forwarding instructions 618 may also include instructions 622 to generate a join request for the multicast group based on a multicast protocol, which allows devices to request multicast traffic. This multicast protocol can be a client multicast protocol, such as IGMP or MLD, using which a device can request multicast traffic. In the example in FIG. 1, upon receiving notification message 168, network device 152 can generate a client join request 170. Furthermore, forwarding instructions 618 may also include instructions 624 to send the join request to a third network device in an external network, which is outside of and is coupled to the overlay network. In the example in FIG. 1, network device 152 can send join request 170 to border device 112 in segment 110.

Forwarding instructions 618 may include instructions 626 to receive multicast traffic of the multicast group from the third network device. In the example in FIG. 1, network device 152 can receive multicast traffic 172 from border device 112. Forwarding instructions 618 may include instructions 628 to send the multicast traffic via the tunnel to the second network device based on the notification message. To do so, computer system 600 can encapsulate the multicast traffic with an encapsulation header with the multicast address indicated in the notification message as the destination address. In the example in FIG. 1, network device 152 can encapsulate multicast traffic 172 with an encapsulation header and send encapsulated multicast traffic 174 to network device 154.

Data 630 can include any data that is required as input, or that is generated as output by the methods, operations, communications, and/or processes described in this disclosure. Specifically, data 630 can include port identifiers of ports from which join requests are received (e.g., respective identifiers ports 202 and 216 in FIG. 2) and port identifiers of ports from which multicast traffic is received (e.g., respective identifiers ports 204 and 218 in FIG. 2). Data 630 can also include a multicast address of a multicast group (e.g., multicast address 250 in FIG. 2).

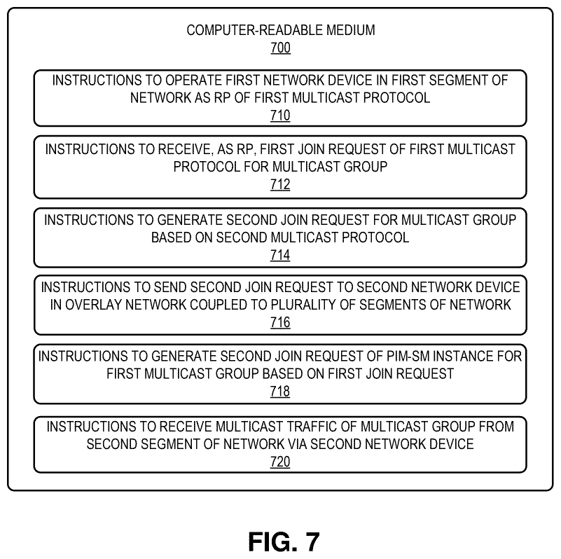

Computer system 600 and forwarding instructions 618 may include more instructions than those shown in FIG. 6. For example, forwarding instructions 618 can also store instructions for encapsulating multicast traffic 172 to generate encapsulated multicast traffic 174 of FIG. 1; decapsulating the multicast header of encapsulated multicast traffic 174 to obtain multicast traffic 172 of FIG. 1; generating data structure entries 284 and 286 of FIG. 2; generating mroutes 294 and 296 of FIG. 2; the operations depicted in the flowcharts of FIGS. 3, 4, and 5; and the instructions of non-transitory CRM 700 in FIG. 7.

FIG. 7 illustrates an example of a CRM facilitating multicast traffic forwarding between segments of a network running different multicast protocol variants, in accordance with an aspect of the present application. CRM 700 can include one or more non-transitory computer-readable mediums or devices storing instructions that, when executed by a computer or processor, cause the computer or processor to perform a method. Therefore, the instructions in CRM 700 can be stored in one or more non-transitory computer-readable mediums or devices. CRM 700 can store instructions 710 to operate a first network device as an RP of a first multicast protocol in a first segment of a network. In the example in FIG. 1, border devices 112, 122, and 132 can operate as RPs of the multicast protocols running on segments 110, 120, and 130, respectively.

CRM 700 can also include instructions 712 to receive, operating as the RP, a first join request of the first multicast protocol for a multicast group. In the example in FIG. 1, because border device 122 can operate as the RP in segment 120, network join request 164 (e.g., PIM join) can be forwarded to border device 122. CRM 700 can include instructions 714 to generate a second join request for the multicast group based on the second multicast protocol. In the example in FIG. 1, upon receiving join request 164 from network device 126, border device 122 can generate a corresponding client join request 166 (e.g., an IGMP join) based on the information indicated in join request 164.

CRM 700 can also include instructions 716 to send the second join request to a second network device in an overlay network coupled to a plurality of segments of the network. In the example in FIG. 1, since border device 122 is coupled to overlay network 150, border device 122 can send join request 166 to overlay network 150. Moreover, CRM 700 can include instructions 718 to receive the multicast traffic of the multicast group from the second segment via the second network device. In the example in FIG. 1, when network device 154 receives encapsulated multicast traffic 174, network device 154 can decapsulate the encapsulation header and obtain multicast traffic 172. Based on join request 166 received from border device 122, network device 154 can forward multicast traffic 172 to border device 122.

CRM 700 may include more instructions than those shown in FIG. 7. For example, CRM 700 can also store instructions for determining network device 152 as an upstream device in overlay network 150 of FIG. 1; determining that a source of multicast group 140 is outside of segment 120 of FIG. 1; generating data structure entry 282 of FIG. 2; generating mroute 292 of FIG. 2; the operations depicted in the flowcharts of FIGS. 3, 4, and 5; and the instructions of computer system 600 in FIG. 6.

The description herein is presented to enable any person skilled in the art to make and use the invention, and is provided in the context of a particular application and its requirements. Various modifications to the disclosed examples will be readily apparent to those skilled in the art, and the general principles defined herein may be applied to other examples and applications without departing from the spirit and scope of the present invention. Thus, the present invention is not limited to the examples shown, but is to be accorded the widest scope consistent with the claims.

One aspect of the present technology can provide a first network device in a first segment of a network. During operation, the first network device can operate as an RP of a first multicast protocol. A respective multicast route in the first segment is established based on the first multicast protocol. Operating as an RP, the first network device can receive a first join request of the first multicast protocol for a multicast group. The first network device can then generate a second join request for the multicast group based on a second multicast protocol and send the second join request to a second network device in an overlay network coupled to a plurality of segments of the network. Subsequently, the first network device can receive multicast traffic of the multicast group from a second segment of the network via the second network device.

In a variation on this aspect, the first network device can store information from the first join request in a data structure. Upon receiving the multicast traffic, the first network device can generate a multicast route based on the information in the data structure.

In a further variation, the first network device can program the forwarding hardware of the first network device with the multicast route. The first network device can then forward the multicast traffic based on the multicast route of the forwarding hardware via a port of the first network device. Here, the first join request is received via the port.

In a variation on this aspect, the first join request can be based on one of: Protocol Independent Multicast (PIM) sparse-mode (PIM-SM) and bidirectional PIM (PIM-BIDIR), Multicast Border Gateway Protocol (MBGP), Distance Vector Multicast Routing Protocol (DVMRP), Core Based Trees (CBT), and Source-Specific Multicast (SSM).

In a variation on this aspect, the second join request can be based on one of: Internet Group Management Protocol (IGMP) and a Multicast Listener Discovery (MLD).

In a variation on this aspect, to send the second join request, the first network device can determine that a source of the multicast group is outside of the first segment and determine the second network device of the overlay network as an upstream network device. The first network device can then send the second join request via a second port of the network device, wherein the second port is coupled to the second network device.

In a further variation, the first network device can receive the multicast traffic from the second network device via the second port.

Another aspect of the present technology can provide a first network device in an overlay network. During operation, the first network device can receive a notification message comprising information indicating that a device reachable via a second network device of the overlay network has requested traffic of a multicast group. Here, the notification message can be received from a tunnel in the overlay network between the first and second network devices. The first network device can then generate a join request for the multicast group based on a multicast protocol which allows devices to request multicast traffic. The first network device can send the join request to a third network device in an external network, which is outside of and is coupled to the overlay network. Subsequently, the first network device can receive multicast traffic of the multicast group from the third network device and send the multicast traffic via the tunnel to the second network device based on the notification message.

In a variation on this aspect, the first network device can store the information of the notification message in a data structure. Upon receiving the multicast traffic, the first network device can generate a multicast route based on the information in the data structure.

In a further variation, the first network device can program the forwarding hardware of the first network device with the multicast route. The first network device can then forward the multicast traffic based on the multicast route of the forwarding hardware. Here, the multicast route can indicate the tunnel as the egress interface.

In a variation on this aspect, the join request can be based on one of: IGMP and MLD.

In a variation on this aspect, the external network can include a plurality of segments. Here, a source of the multicast group can be reachable via a first segment from the first network device. Furthermore, the device can be reachable via a second segment coupled to the second network device.

In a variation on this aspect, the notification message can be an EVPN type-6 message comprising a first IP address of the multicast group and a second IP address of the second network device.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disks, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described herein can be executed by and/or included in hardware logic blocks or apparatus. These logic blocks or apparatus may include, but are not limited to, an application-specific integrated circuit (ASIC) chip, a field-programmable gate array (FPGA), a dedicated or shared processor that executes a particular software logic block or a piece of code at a particular time, and/or other programmable-logic devices now known or later developed. When the hardware logic blocks or apparatus are activated, they perform the methods and processes included within them.

The foregoing descriptions of examples of the present invention have been presented only for purposes of illustration and description. They are not intended to be exhaustive or to limit this disclosure. Accordingly, many modifications and variations will be apparent to practitioners skilled in the art. The scope of the present invention is defined by the appended claims.

What is claimed is:

1. A method, comprising:
operating a first network device in a first segment of a network as a rendezvous point (RP) of a first multicast protocol, wherein a respective multicast route in the first segment is established based on the first multicast protocol;
receiving, by the first network device operating as the RP, a first join request of the first multicast protocol for a multicast group;
generating, by the first network device, a second join request for the multicast group based on a second multicast protocol;
sending, by the first network device, the second join request to a second network device in an overlay network coupled to a plurality of segments of the network; and
receiving, by the first network device, multicast traffic of the multicast group from a second segment of the network via the second network device.

2. The method of claim 1, further comprising:
storing, by the first network device, information from the first join request in a data structure; and
in response to receiving the multicast traffic, generating, by the first network device, a multicast route based on the information in the data structure.

3. The method of claim 2, further comprising:
programming a forwarding hardware of the first network device with the multicast route; and
forwarding the multicast traffic based on the multicast route of the forwarding hardware via a port of the first network device, wherein the first join request is received via the port.

4. The method of claim 1, wherein the first join request is based on one of: Protocol Independent Multicast (PIM) sparse-mode (PIM-SM) and bidirectional PIM (PIM-BIDIR), Multicast Border Gateway Protocol (MBGP), Distance Vector Multicast Routing Protocol (DVMRP), Core Based Trees (CBT), and Source-Specific Multicast (SSM).

5. The method of claim 1, wherein the second join request is based on one of: Internet Group Management Protocol (IGMP) and Multicast Listener Discovery (MLD).

6. The method of claim 1, wherein sending the second join request comprises:
determining that a source of the multicast group is outside of the first segment;
determining the second network device of the overlay network as an upstream network device; and
sending the second join request via a second port of the network device, wherein the second port is coupled to the second network device.

7. The method of claim 6, wherein receiving the multicast traffic further comprises receiving the multicast traffic from the second network device via the second port.

8. A method, comprising:
receiving, by a first network device in an overlay network, a notification message comprising information indicating that a device reachable via a second network device of the overlay network has requested traffic of a multicast group, wherein the notification message is received from a tunnel in the overlay network between the first and second network devices;
generating, by the first network device, a join request for the multicast group based on a multicast protocol which allows devices to request multicast traffic;
sending, by the first network device, the join request to a third network device in an external network, which is outside of and is coupled to the overlay network;
receiving, by the first network device, multicast traffic of the multicast group from the third network device; and
sending, by the first network device, the multicast traffic via the tunnel to the second network device based on the notification message.

9. The method of claim 1, further comprising:
storing, by the first network device, the information of the notification message in a data structure; and
in response to receiving the multicast traffic, generating, by the first network device, a multicast route based on the information in the data structure.

10. The method of claim 9, further comprising:
programming a forwarding hardware of the first network device with the multicast route; and
forwarding the multicast traffic based on the multicast route of the forwarding hardware, wherein the multicast route indicates the tunnel as an egress interface.

11. The method of claim 8, wherein the join request is based on one of:
Internet Group Management Protocol (IGMP) and Multicast Listener Discovery (MLD).

12. The method of claim 8, wherein the external network comprises a plurality of segments, wherein a source of the multicast group is reachable via a first segment from the first network device, and wherein the device is reachable via a second segment coupled to the second network device.

13. The method of claim 8, wherein the notification message is an Ethernet Virtual Private Network (EVPN) type-6 message comprising a first Internet Protocol (IP) address of the multicast group and a second IP address of the second network device.

14. A non-transitory computer-readable storage medium storing instructions to:
operate a first network device in a first segment of a network as a rendezvous point (RP) of a first multicast protocol, wherein a respective multicast route in the first segment is established based on the first multicast protocol;
receive, at the first network device operating as the RP, a first join request of the first multicast protocol for a multicast group;
generate, at the first network device, a second join request for the multicast group based on a second multicast protocol;
send, at the first network device, the second join request to a second network device in an overlay network coupled to a plurality of segments of the network; and
receive, at the first network device, multicast traffic of the multicast group from a second segment of the network via the second network device.

15. The non-transitory computer-readable storage medium of claim 14, wherein the instructions are further to:
store, at the first network device, information from the first join request in a data structure; and
in response to receiving the multicast traffic, generate, at the first network device, a multicast route based on the information in the data structure.

16. The non-transitory computer-readable storage medium of claim 15, wherein the instructions are further to:
program a forwarding hardware of the first network device with the multicast route; and
forward the multicast traffic based on the multicast route of the forwarding hardware via a port of the first network device, wherein the first join request is received via the port.

17. The non-transitory computer-readable storage medium of claim 14, wherein the first join request is based on one of: Protocol Independent Multicast (PIM) sparse-mode (PIM-SM) and bidirectional PIM (PIM-BIDIR), Multicast Border Gateway Protocol (MBGP), Distance Vector Multicast Routing Protocol (DVMRP), Core Based Trees (CBT), and Source-Specific Multicast (SSM).

18. The non-transitory computer-readable storage medium of claim 14, wherein the second join request is based on one of: Internet Group Management Protocol (IGMP) and a Multicast Listener Discovery (MLD).

19. The non-transitory computer-readable storage medium of claim 14, wherein, to send the second join request, the instructions are further to:
determine that a source of the multicast group is outside of the first segment;
determine the second network device of the overlay network as an upstream network device; and
send the second join request via a second port of the network device, wherein the second port is coupled to the second network device.

20. The non-transitory computer-readable storage medium of claim 14, wherein, to receive the multicast traffic, the instructions are further to receive the multicast traffic from the second network device via the second port.
